(19) United States
(12) Patent Application Publication
(10) Pub. No.: US 2007/0289201 A1
(43) Pub. Date: Dec. 20, 2007

(54) Electronic Pest Deterrent

(76) Inventor: R. Amil Kleinert, Charlestown, IN (US)

Correspondence Address: JOAN L. SIMUNIC, P.O. BOX 443, LA GRANGE, KY, 40031-0443, US

(21) Appl. No.: 11/424,034

(22) Filed: Jun. 14, 2006

(51) Int. Cl. A01M 23/38; A01M 23/00; G08B 23/00; A01K 15/04

(52) U.S. Cl. 43/98; 340/573.2; 119/765; 43/58

(57) ABSTRACT

The present development relates to a pest control device that is effective because it uses a mild shock to train animals to associate a designated area with a painful sensation. The device has a base with a bait cup rigged to form an open circuit with a power source mounted to the base. When an animal attempts to eat the bait, the animal closes the electrical circuit and receives a mild electrical shock.

### CROSS-REFERENCE TO PRIOR APPLICATIONS

The present application claims priority to U.S. provisional patent application 60/664,270 filed Mar. 23, 2005 and to U.S. provisional patent application 60/666,248 filed Mar. 23, 2005 and to U.S. patent application Ser. No. 11/387,596 filed Mar. 23, 2006, all of which are incorporated herein in their entirety by reference.

### BACKGROUND

The present invention is a pest control device intended to deter wildlife from attacking planted areas, such as landscaped gardens or water gardens, or to keep wildlife from roosting on structures. The device functions by emitting a mild shock when an animal touches the device. The animal learns to associate the area or plant with the shock sensation and thus avoids the area or plant.

Young trees, small shrubs, garden plants, water plants and ornamental fish are often attractive food sources for wildlife such as deer, beaver, rabbits, fowl, and members of the rodent families. The wildlife may also rub against the trunk of a tree, gnaw at the bark or pull at the leaves of the tree, thereby injuring, and oftentimes, destroying the tree. In congested areas, pigeons and other birds roost on structures and near windows on buildings, often creating nuisances for local residents in addition to leaving unsightly waste.

It is often difficult to prevent animals from attacking gardens and ponds by merely using fencing or similar physical blockades. If the animal is large enough, it can easily step over the fencing or knock the fencing down in order to reach the desired site. However, animals can be trained to avoid certain areas if they associate the area with pain rather than with pleasure. This theory serves as the basis for invisible fencing commonly used to contain a dog within its owner's yard. When the dog is wearing a collar that is activated by a hidden electrified wire, the dog receives a mild shock whenever it moves within a predetermined range of the wire. Although there is no physical barrier to restrict the dog's movements, the dog eventually learns to associate the perimeter of the yard with pain, and thus, the dog tends to remain within the center of the yard. Using a similar approach, free-roaming animals can be taught to avoid designated areas by subjecting the animal to a mildly painful sensation when the animal reaches the perimeter of the area, thereby encouraging the animal to move to a new location rather than to enter the designated area.

### SUMMARY OF THE PRESENT INVENTION

The present invention is a pest control device that delivers a mild electric shock pulse to an animal when the animal completes an electric circuit within the device. The device comprises an electric grid mounted to a base, wherein the grid is wired to a power source attached to the base and forms an open circuit. When an animal makes contact with the grid, the animal causes a closed circuit to form and the animal receives a mild electric shock. The device may be freestanding, or it may be attached to a post or similar support, or it may include a hangar so it can be attached to a tree or plant branch, or it may be allowed to float on the surface of water.

### BRIEF DESCRIPTION OF THE FIGURES

FIG. 1 is a perspective view of the device shown hanging on a tree branch;

FIG. 2 is a bottom perspective view of the device of FIG. 1;

FIG. 3 is a side view of the device of FIG. 1;

FIG. 4 is a top view of the device of FIG. 1; and

FIG. 5 is a bottom view of the device of FIG. 1.

### DETAILED DESCRIPTION OF THE INVENTION

The pest control device of the present invention is designed to provide an electrical shock pulse to deter animal contact with a tree or plant or area the user wishes to protect from animal intrusion. The device has a shocking mechanism that delivers an electric shock similar to an electric dog collar or a livestock prod. The device is essentially in an “open circuit” arrangement until an animal closes the circuit causing the electric shock. Although the expected primary use of the pest control device would be in outdoor settings, the device may also be used indoors, such as in a residence or in a barn, to keep pets and other small animals away from designated areas.

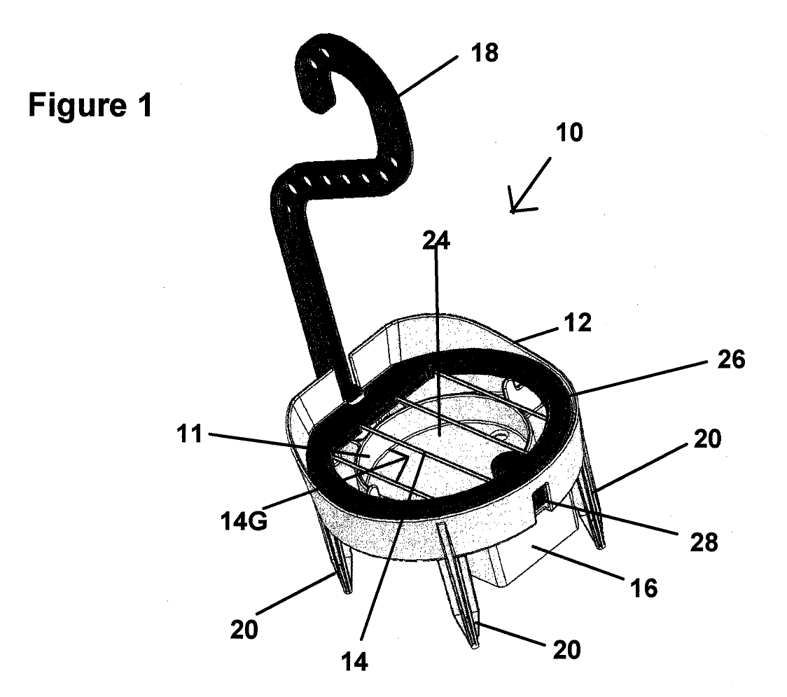

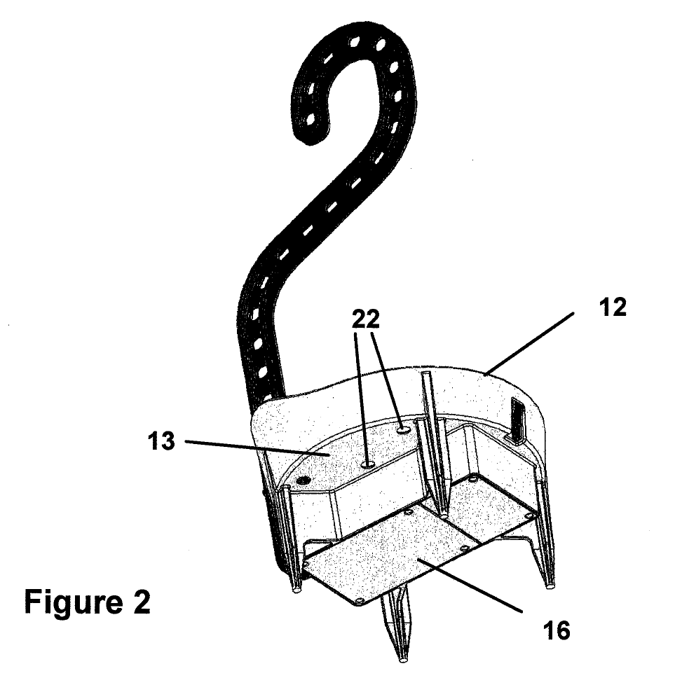

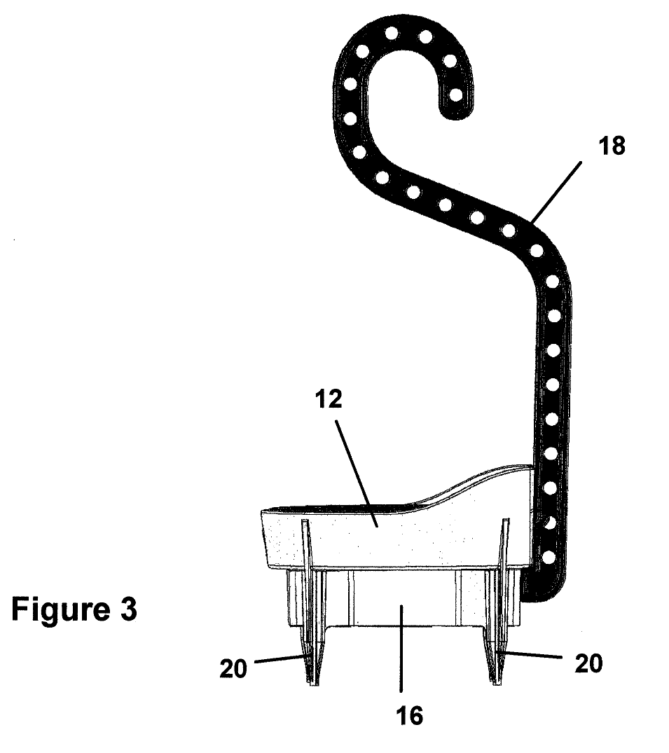

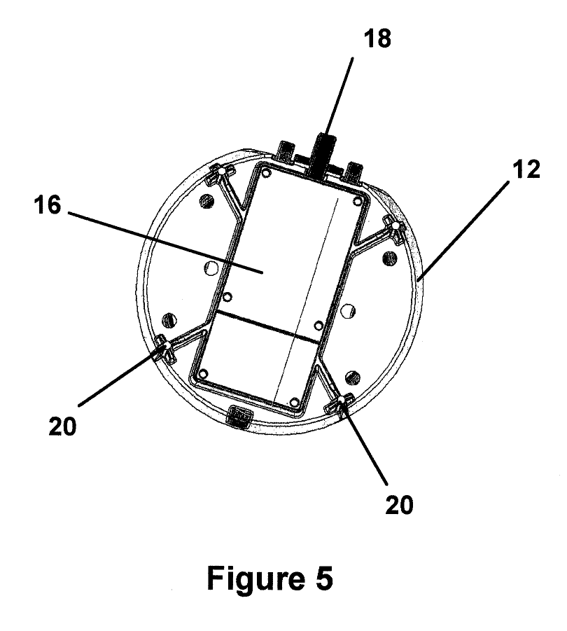

An embodiment of a pest control device made according to the invention is shown in FIGS. 1-5. As shown in the Figures, the device 10 has a base 12, a means for conducting electricity 14 and an electrical source 16. Optionally, the device may include a hangar 18 or legs 20 or drain holes 22, although these features are not required for the device 10 to function as intended.

The base 12 is preferably made of plastic or a similar material that generally acts as an insulator with respect to conducting electrical impulses. If the pest control device 10 will be marketed for outdoor use, it is recommended, though not required, that the material selected be capable of withstanding variations in temperature and weather conditions. Alternatively, if the pest control device 10 will be marketed for use in a climate-controlled environment, less durable materials may be used for the base 12.

The base 12 may have any shape that can allow for bait to be deposited on an upper side 11 of the base 12. For example, as shown in FIGS. 1-5, the base 12 is an essentially circular cup having a depressed center 24 for placement of bait. In a first alternative embodiment, the bait may be placed in a raised cup or dish (not shown) that is attached to the upper side 11 of the base 12. In a second alternative embodiment, the base 12 has a shape with a horizontal surface area of sufficient dimensions to allow the device 10 to float when suspended in water.

The means for conducting electricity 14 is mounted to the base 12 such that when an animal attempts to ingest bait from the upper side 11 of the base 12 the conducting means 14 is activated so that the animal receives a mild shock. The conducting means 14 may be projecting wires or shocking points or shocking rings or an electrified grid or any other design known in the art that forms of an open circuit when the conducting means 14 is connected to the electrical source 16 and is in a resting position.

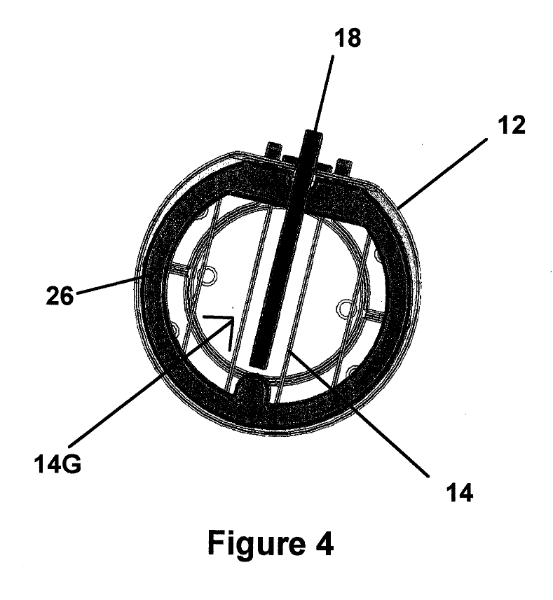

For example, as shown in FIGS. 1 and 4, the conducting means 14 is a first wire connected to the electrical source 16 to produce a positive charge and a second wire connected to the electrical source 16 to produce a negative charge, wherein the wires are arranged to form a grid 14G of essentially parallel wire lines and, in the resting position, the first wire is not in communication with the second wire at any point on the grid. Optionally, the grid 14G may be held in position by a plastic or similar material frame 26. In the embodiment shown in FIG. 1, the frame 26 includes a latch 28 that allows a user to lift the grid 14G to fill the depression 24 with bait and then to lower the grid 14G over the bait and to snap the latch 28 to a corresponding portion of the base 12 to securely hold the grid in position over the bait.

Alternatively, the conducting means 14 may comprise a metal wire or metal plate (not shown) mounted to the upper side 11 of the base 12 in communication with a first wire having a designated charge and a metal bait tray (not shown) in communication with a second wire having an opposite charge from the first wire. The metal bait tray is mounted to the upper side 11 of the base 12 in such a manner that the tray is not in communication with the plate when in the resting position. However, when a pressure is exerted on the tray, such as when an animal attempts to feed on the bait, the tray is forced toward the upper side 11 of the base 12 and makes contact with the plate and first wire.

The electrical source 16 is a battery or a solar powered generator or any similar means for producing an electrical shock when a closed circuit is formed with the electrical source 16. The electrical source 16 is mounted to the base 12 and to the conducting means 14 such that a line for carrying positive charge is present and a separate line for carrying negative charge is present. In the embodiment shown in FIGS. 1-5, the electrical source 16 is mounted to an underside 13 of the base 12. Optionally, the source 16 may be housed within an enclosure secured to the base 12. When the pest control device 10 is used outdoors, it is recommended, but not required, that the electrical source 16 be housed within an enclosure that is made of plastic or a similar material that generally acts as an insulator with respect to conducting electrical impulses and that is capable of withstanding variations in temperature and weather conditions. Alternatively, the electrical source 16 may be an alternating current (AC) source. Because AC power requires an external power source, the range of use of the pest control device 10 may be limited.

The electrical source 16 should be of adequate voltage to deliver an electrical shock when the circuit is closed, but should be of sufficiently low voltage that even small animals or children could not be injured by the resulting shock. For example, a power source 16 with a voltage supply of about 9 V is adequate in most applications, but any multiple of 1.5 V batteries may be used. Optionally, it is recommended, but not required, that the power source 16 be configured to include a cut-off switch so that the closed electrical circuit would automatically be re-opened after a predetermined time period. Cut-off switches for this type of timed out application are well-known in the art. For the pest control device 10, a cut-off switch that is activated after the circuit is closed for up to about a 5 second period should be adequate for most intended uses.

It should be noted that the embodiment presented in FIGS. 1-5 has intentionally been simplified for presentation herein. However, as is known in the fields of mechanical arts and electrical arts, there are numerous ways to configure an electrical source and wires to produce an open circuit in a resting position but a closed circuit when some force is applied to the system. These may include, without limitation, rigging the grid or bait tray to toggle an on-off switch for the electrical source.

Optionally, the pest control device 10 may include drain holes 22 in the base 12. When the device 10 is used in an outdoor setting, there is a relatively high probability that the device will be exposed to rain or snow which may pool on the upper side 11 of the base 12. The addition of drain holes 22 allows water to exit the base 12. When drain holes 22 are included in the device 10, they should be positioned so as to avoid being in direct contact with the power source 16 or from draining into any housing provided for the power source 16.

Optionally, the pest control device 10 may include one or more legs 20 protruding from the underside 13 of the base. When legs 20 are included on the device 10, they should be long enough to ensure that the power source 16 will not make direct contact with a surface when the legs 20 are resting on the surface. As shown in FIGS. 1-5, the legs 20 may be evenly spaced around the underside 13 of the base 12. Alternatively, a single leg 20 of adequate dimensions to support the base 12 when filled with bait, the means for providing an electrical current 14, and the power source 16 may be positioned either on the underside 13 of the base 12 or on a housing provided for the power source 16 so that the pest control device 10 provides its own support post.

Optionally, the pest control device 10 may include a support means 18 to allow the user to position the device 10 on a post or stake or tree branch. Some representative examples of such means for positioning the device include, but are not limited to, an open bracket, a closed bracket, a hook, a tether, a plant hanger, and combinations thereof. It is recommended, but not required, that the support means 18 be adapted to allow the user to alter the relative position of the pest control device 10 so the device 10 can be positioned at the appropriate height from ground level to target the pest.

Optionally, the pest control device 10 may include a tethering means (not shown) attached to the base 12 that can help minimize movement or sway of the device 10 that may be caused by wind or by an animal pushing against the device 10. Some representative examples of tethering means include, but are not limited to, a barbed hangar, a cord, a hook, or other elements that allow the base 12 to be held in a relatively rigid position when in use.

It is not necessary to provide a ground connection for the pest control device 10 provided the device 10 is proportioned such that any animal closing the electrical circuit can provide grounding for the circuit. If the device 10 will be used in a manner that will not allow for animal grounding of the circuit, then a separate ground connection may be provided by running a wire from the conducting means 14 to ground, as is known in the art.

It is anticipated that the pest control device 10 will be used primarily to protect landscaped outdoor areas from deer or similar animals that generally like to feed on tender foliage. Typically, the device 10 would be placed near an exterior edge of the landscaped area. A bait that is particularly attractive to the target animal, such as peanut butter, nuts, grain, seeds or other attractive food, is placed on the upper side 11 of the base 12. As the animal attempts to eat the bait, the animal pushes against the conducting means 14 closing the circuit and delivering an electrical shock to the animal. After one or more attempts to get the bait, the animal normally moves to a new feeding ground rather than to risk the minor pain associated with food from the area near the pest control device 10. Further, by using an electrical pulse supplied only when required, the power source demand can be reduced, and battery life extended.

Optionally, the pest control device 10 may be designed such that the conducting means 14 can only close the circuit when a predetermined amount of pressure is exerted against the base 12. This can allow the device 10 to be used, for example, as a bird feeder. The recessed area 24 of the base 12 can be filled with seeds and other bird feed and covered with a wire grid 14G having spacings large enough for a bird to pass its beak through to reach the seeds. The wire grid 14G is positioned over the base 12 such that in the resting position the conducting means 14 are separated from the power source 16 by a predetermined distance, but when the grid 14G is pushed toward the base 12, the conducting means 14G is placed in communication with the power source 16 and an electrical shock is produced. The distance for separation in the resting state is determined by the types of materials used for the grid and base—for example, more elastic materials will accommodate a larger separation than will more rigid materials—and the relative masses of the animals that are to be allowed access to the food as compared to the animals that are to be deterred from getting the food—for example, a robin may be allowed to feed while a squirrel would be an unwelcome guest.

The pest control device 10 of the present application may also be used as a mouse/rat/rodent trap. In this application, bait attractive to the rodent would be placed on the upper surface 11 of the base 12 and the electrical source 16 would have a relatively high voltage. When the rodent attempts to reach the bait, the rodent causes the circuit between the conducting means 14 and the electrical source 16 to close while delivering a lethal electric shock to the rodent. Because most household rodents are smaller in size than domestic pets, the voltage level of the power source 16 may be selected so as to be lethal to very small animals but to merely deliver a shock to larger animals.

Various additions may be made to the pest control device 10 to make it more convenient for the end user. For example, an optional hood may be added over the base 12 to deflect rain and snow. Optionally, the device may have a moat or lip surrounding the unit or bait tray to deter crawling insects. An optional light emitting diode (in a visible location) may be added to indicate when the unit is operational.

Those versed in the field of tree and plant protection will understand there are other variations of this principal that may be obvious. Animals other than those specified herein may also be thwarted by the present pest control device, and other objects and subjects may be protected by the present pest control device. Using the technology described herein, it is also possible for the pest control device 10 to be configured to emit electronic distress calls or other deterring sounds in addition to or rather than delivering an electric shock to the invading animal. Such sounds could also be triggered by use of a motion sensor trigger or photo electric eye switch, as are known in the art.

What is claimed is:

1. A pest control device comprising:
(a) a base, having an upper side;
(b) an electric source, secured to said base; and
(c) a conducting means comprising a first wire and a second wire, wherein said first wire is in communication with said electric source to produce a charge and said second wire is in communication with said electric source to produce an opposing charge and said first wire and second wire are separated by a predetermined distance, and wherein said conducting means is positioned on said base upper side.

2. The pest control device of claim 1 wherein said base is made from a non-electricity conducting material.

3. The pest control device of claim 1 wherein said conducting means first wire and second wire are in a grid pattern.

4. The pest control device of claim 3 wherein said grid includes a frame along the periphery.

5. The pest control device of claim 1 wherein said base comprises a bait cup.

6. The pest control device of claim 5 wherein said bait cup is covered by said conducting means.

7. The pest control device of claim 1 wherein said base comprises a tray in communication with said first wire, and wherein said base comprises a plate in communication with said second wire, and wherein said tray and said plate are separated by a predetermined distance.

8. The pest control device of claim 1 wherein said electrical source is a battery or a solar powered generator or alternating current.

9. The pest control device of claim 1 wherein said base further includes a housing capable of enclosing said electrical source.

10. The pest control device of claim 1 wherein said base further comprises at least one drain hole.

11. The pest control device of claim 1 wherein said base further comprises at least one leg.

12. The pest control device of claim 1 further comprising a means to hang said pest control device.

13. A pest control device comprising:
(a) a base, made from a non-electricity conducting material, and having a bait cup on a first side;
(b) an electric source, secured to said base; and
(c) a conducting means comprising a first wire and a second wire arranged in a grid wherein said first wire and second wire are separated by a predetermined distance,
and wherein said conducting means grid is positioned on said base so as to cover said bait cup and said conducting means grid first wire is in communication with said electric source to produce a charge and said second wire is in communication with said electric source to produce an opposing charge.

14. The pest control device of claim 13 wherein said grid includes a frame along the periphery.

15. The pest control device of claim 13 wherein said electrical source is a battery or a solar powered generator or alternating current.

16. The pest control device of claim 13 wherein said base further includes a housing capable of enclosing said electrical source.

17. The pest control device of claim 13 wherein said base further comprises at least one drain hole.

18. A pest control device comprising:
(a) a base, made from a non-electricity conducting material, comprising a tray and a plate, wherein said tray and said plate are separated by a predetermined distance;
(b) an electric source, secured to said base; and
(c) a conducting means comprising a first wire having a charge and being in communication with said base tray and with said electric source, and a second wire having an opposing charge and being in communication with said base plate and with said electric source.

19. The pest control device of claim 18 wherein said electrical source is a battery or a solar powered generator or alternating current.

20. The pest control device of claim 18 wherein said base further comprises at least one drain hole.
